(19) United States
(12) Patent Application Publication
(10) Pub. No.: US 2015/0023416 A1
(43) Pub. Date: Jan. 22, 2015

(54) IMAGE ENCODING DEVICE AND IMAGE DECODING DEVICE

(71) Applicant: Kabushiki Kaisha Toshiba, Minato-ku (JP)

(72) Inventors: Tatsuya Tanaka, Kawasaki-shi (JP); Atsushi Matsumura, Yokohama-shi (JP)

(73) Assignee: Kabushiki Kaisha Toshiba, Minato-ku (JP)

(21) Appl. No.: 14/333,956

(22) Filed: Jul. 17, 2014

(30) Foreign Application Priority Data
Jul. 22, 2013 (JP) 2013-151865

(51) Int. Cl. H04N 19/85; H04N 19/44

(52) U.S. Cl. CPC H04N 19/00903; H04N 19/00533
USPC 375/240.08

(57) ABSTRACT

According to an embodiment, an image encoding device assigns colors to pixels in a pixel block to encode an image. The device includes a generating unit to generate one or more provisional representative colors for pixels to be encoded and provisional indices for identifying the provisional representative colors based on colors assigned to encoded pixels; a updating unit to generate one or more determined representative colors to be used for expressing the pixels in the pixel block and indices for individually identifying the determined representative colors based on the pixels to be encoded and the provisional representative colors, and generate update information for updating the provisional representative colors and the provisional indices with the determined representative colors and the indices; an assigning unit to generate assignment information indicating the indices assigned to the pixels to be encoded; and an encoding unit to encode the update information and the assignment information.

### CROSS-REFERENCE TO RELATED APPLICATIONS

This application is based upon and claims the benefit of priority from Japanese Patent Application No. 2013-151865, filed on Jul. 22, 2013; the entire contents of which are incorporated herein by reference.

### FIELD

Embodiments described herein relate generally to an image encoding device and an image decoding device.

### BACKGROUND

For compression of natural image data, JPEG for static images and MPEG for moving images can be used to efficiently compress data. In contrast, for computer graphics (CG) data such as a screen of a personal computer (PC), color palette image coding in which pixels are expressed using multiple representative colors (palette) allows more efficient data compression than the aforementioned techniques.

In the image coding using color palettes, representative color information indicating what representative colors are used to express a pixel block to be encoded and index information indicating what representative color is used to express each pixel in the pixel block are output as encoded data for each pixel block to be encoded. In related art, for encoding representative color information, there is a technique of encoding in a special mode in which continuity of representative colors of pixel blocks is taken into consideration when the representative color information of an encoded pixel block is entirely the same as the representative color information of a pixel block to be encoded. When colors are assigned to respective pixels of an image in units of pixel blocks and the image is sequentially encoded, however, there has been a disadvantage that all the representative colors of encoded pixel blocks and all the representative colors of a pixel block to be encoded are less likely to be the same as the number of representative colors in pixel blocks is larger, which cannot produce the effect of reducing the amount of information (data amount).

### BRIEF DESCRIPTION OF THE DRAWINGS

FIG. 1 is a block diagram illustrating an image encoding device according to an embodiment;

FIG. 2 is a flowchart illustrating processes performed by the image encoding device;

FIG. 3 is a diagram illustrating pixel blocks to be encoded and reference pixel blocks;

FIG. 4 is a diagram illustrating a result of generating provisional representative colors;

FIG. 5 is a flowchart illustrating an update process in which an updating unit updates the provisional representative colors with representative colors;

FIG. 6 is a diagram illustrating a result of updating the provisional representative colors;

FIG. 7 is a diagram illustrating an update result of deleting redundant provisional representative colors to generate final representative colors;

FIG. 8 is a diagram illustrating an update result of deleting redundant provisional representative colors to generate final representative colors;

FIG. 9 is a diagram illustrating update information indicating the update result illustrated in FIG. 6;

FIG. 10 is a diagram illustrating update information;

FIG. 11 is a diagram illustrating representative colors of an encoded pixel block and representative colors of a pixel block to be encoded next;

FIG. 12 is a diagram illustrating encoded data resulting from encoding the update information;

FIG. 13 is a diagram illustrating a result of assigning indices to pixels in a pixel block to be encoded;

FIGS. 14A to 14C are diagrams illustrating an example of encoding indices;

FIG. 15 is a diagram illustrating an example of encoded data encoded and output by an encoding unit;

FIG. 16 is a diagram illustrating a modified example of the encoded data illustrated in FIG. 15;

FIG. 17 is a block diagram illustrating an image decoding device according to an embodiment; and

FIG. 18 is a flowchart illustrating processes performed by the image decoding device.

### DETAILED DESCRIPTION

According to an embodiment, an image encoding device assigns colors to pixels included in a pixel block to encode an image. The device includes a generating unit, an updating unit, an assigning unit, and an encoding unit. The generating unit generates one or more provisional representative colors for pixels to be encoded and provisional indices for identifying the provisional representative colors on the basis of colors assigned to encoded pixels. The updating unit generates one or more determined representative colors to be used for expressing the pixels in the pixel block and indices for individually identifying the determined representative colors on the basis of the pixels to be encoded and the provisional representative colors, and generates update information for updating the provisional representative colors and the provisional indices with the determined representative colors and the indices. The assigning unit generates assignment information in which the respective indices are assigned to the respective pixels in the pixel block to be encoded. The encoding unit encodes the update information and the assignment information.

Embodiments will be described below with reference to the accompanying drawings.

Image Encoding Device

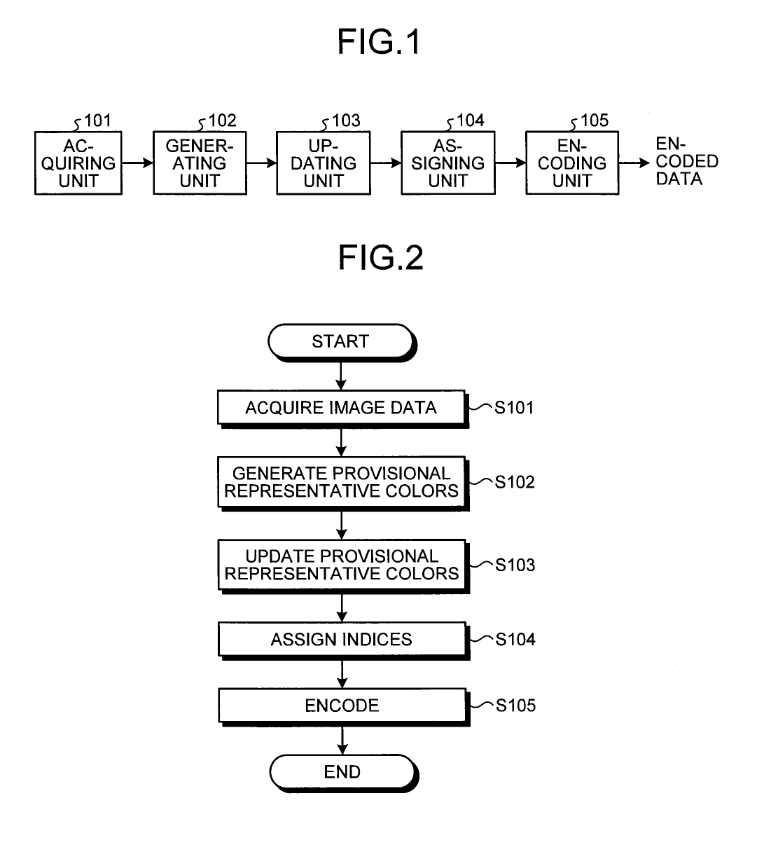

FIG. 1 is a block diagram illustrating an image encoding device according to an embodiment. The image encoding device has functions of a computer including a CPU, a storage unit, a communication interface, and the like, for example. Alternatively, the image encoding device is embedded in an apparatus or a system that mainly handles computer graphics (CG) images such as a screen of a personal computer (PC), for example. The image encoding device can compress CG image data to improve the transmission rate and to reduce the capacity of a DRAM or the like that saves CG image data.

As illustrated in FIG. 1, the image encoding device includes an acquiring unit 101, a generating unit 102, an updating unit 103, an assigning unit 104, and an encoding unit 105. Note that the acquiring unit 101, the generating unit 102, the updating unit 103, the assigning unit 104, and the encoding unit 105 may be either hardware circuits or software executed by a CPU.

The acquiring unit 101 acquires a pixel block that is a unit of processing from an image to be encoded and a reference pixel block of encoded pixels.

The generating unit 102 generates one or more provisional representative colors to be used for expressing respective pixels in the pixel block to be encoded and provisional indices for individually identifying the provisional representative colors on the basis of the colors of encoded pixels (reference pixel block, for example).

The updating unit 103 generates one or more representative colors to be used for expressing the respective pixels in the pixel block and indices for individually identifying the representative colors on the basis of the pixel data in the pixel block to be encoded and the provisional representative colors to generate update information for updating the provisional representative colors and the provisional indices with the representative colors and the indices. Note that the updating unit 103 determines an unnecessary provisional color (a color that is not assigned to any pixel) among the provisional representative colors and a representative color that is needed to be newly added to generate finally determined representative colors.

The assigning unit 104 generates assignment information indicating respective indices assigned to the respective pixels in the pixel block to be encoded to assign any one of the representative colors to each of the pixels in the pixel block to be encoded.

The encoding unit 105 encodes the update information and the assignment information and outputs the resulting encoded data.

Next, processes performed by the image encoding device will be described. FIG. 2 is a flowchart illustrating processes performed by the image encoding device. The acquiring unit 101 acquires a pixel block that is a unit of processing from an image to be encoded and a reference pixel block of encoded pixels. Thus, the acquiring unit 101 acquires image data (S101).

The generating unit 102 generates one or more provisional representative colors to be used for expressing respective pixels in the pixel block to be encoded and provisional indices for individually identifying the provisional representative colors on the basis of the colors of encoded pixels (reference pixel block, for example) (S102).

The updating unit 103 generates one or more representative colors to be used for expressing the respective pixels in the pixel block and indices for individually identifying the representative colors on the basis of the pixel data in the pixel block to be encoded and the provisional representative colors to generate update information for updating the provisional representative colors and the provisional indices with the determined representative colors and the indices. Note that the updating unit 103 determines an unnecessary provisional color among the provisional representative colors and a representative color that is needed to be newly added to generate final representative colors. Thus, the updating unit 103 generates update information for updating the provisional representative colors and the provisional indices determined in the process of S102 and updating the provisional representative colors with the representative colors (S103).

The assigning unit 104 generates assignment information indicating respective indices assigned to the respective pixels in the pixel block to be encoded to assign any one of the representative colors to each of the pixels in the pixel block to be encoded (S104).

The encoding unit 105 encodes the update information generated in the process of S103 and the assignment information generated in the process of S104 (S105). If there remains any pixel block to be processed, the image encoding device returns to the step (S101) of acquiring a pixel block. If processing on all the pixel blocks is completed, the encoding process is terminated.

Next, the processing steps illustrated in FIG. 2 will be individually described in detail.

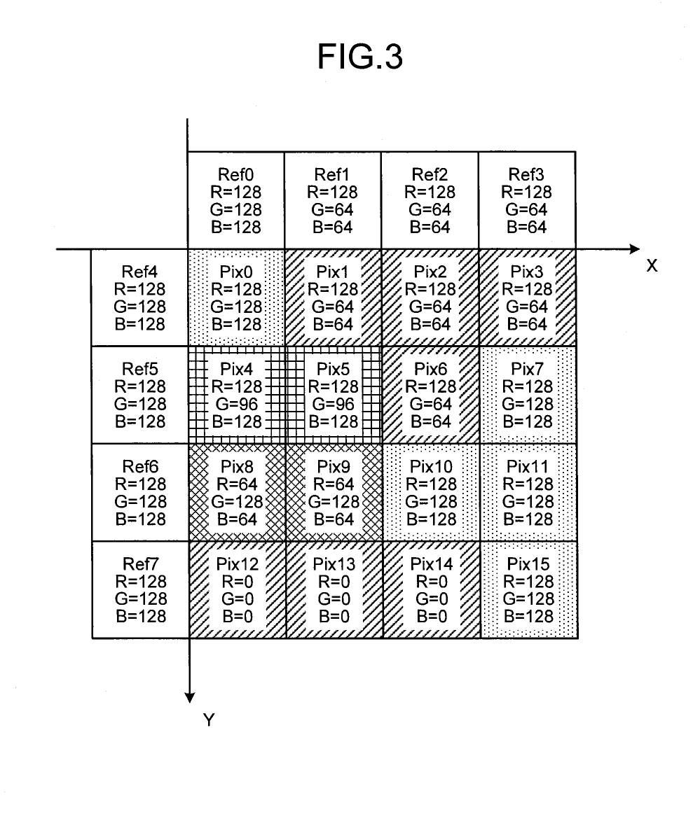

The acquiring unit 101 acquires pixels Pix0 to Pix15 (4×4) illustrated in FIG. 3 as one pixel block, for example. The shape of the pixel block may be any of a square of N×N, a rectangle of M×N, a line of 1×M, and the like (N and M are integers of 1 or larger; N≠M). The acquiring unit 101 also acquires eight pixels Ref0 to Ref7 as a reference pixel block from encoded pixels. The reference pixel block will be described using an example in which upper four pixels and left four pixels adjacent to the pixel block are reference pixels, but the reference pixel block is not limited thereto. For example, the reference pixels may be only the four upper pixels, one line of upper pixels, N×M pixels at predetermined positions relative to the pixels to be encoded, or the like.

The order in which the pixel block is processed (scanned) is a raster scan, for example. Although the color information of the pixels is expressed in an RGB space (the dynamic range of the color information being eight bits [0:255]) in FIG. 3, the color information may be expressed in any other color system such as YUV, YCbCr, and HSV, and the dynamic range is not limited to eight bits.

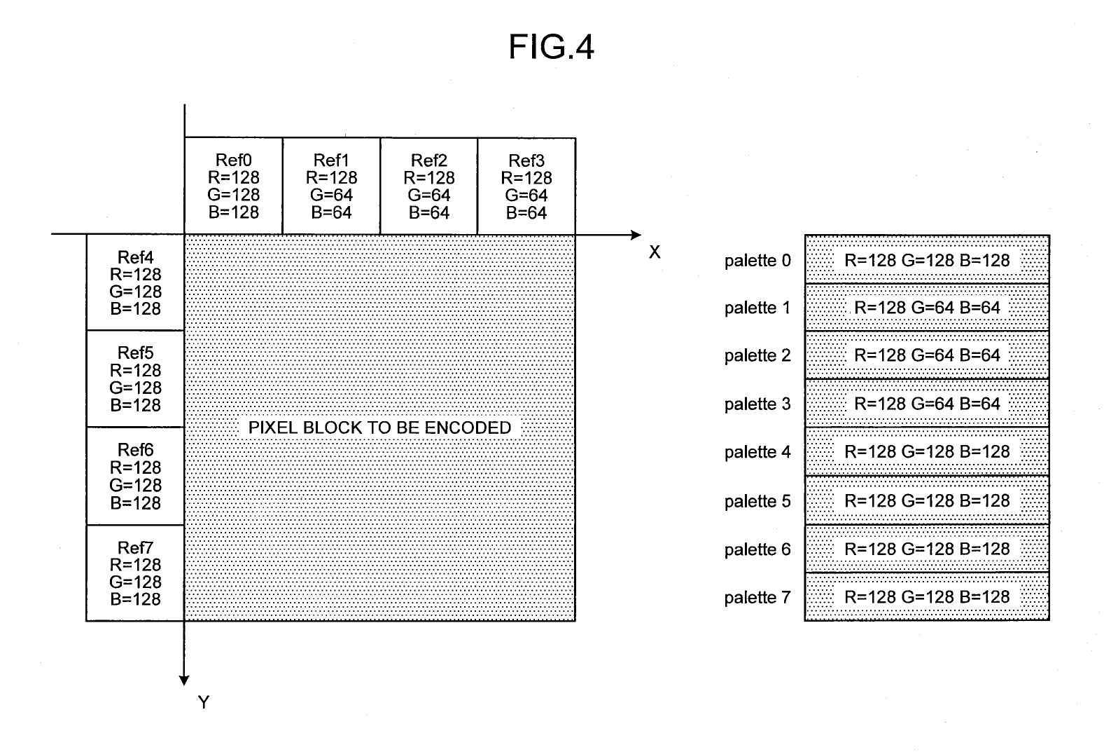

The generating unit 102 determines provisional representative colors on the basis of the reference pixel block. For example, the generating unit 102 assigns pixel values (pixel data) of Ref0 to Ref7 to Palette0 to Palette7 without any change as illustrated in FIG. 4 to generate the provisional representative colors. The generating unit 102 also generates provisional indices (Index0 to Index7) to Palette0 to Palette7, respectively.

Note that the method for generating the provisional representative colors is not limited to the example illustrated in FIG. 4. For example, upper and left reference pixels may be alternately assigned as provisional representative colors in a manner that Palette0 is generated from the pixel value of Ref0, Palette1 is generated from the pixel value of Ref4, Palette2 is generated from the pixel value of Ref1, and so on. Furthermore, the generating unit 102 may quantize lower N bits and use the quantization result as a provisional representative color or may generate a pixel value of a provisional representative color from a plurality of reference pixels such as an average of Ref0 and Ref1, for example, instead of using the pixel value of a reference pixel as a provisional representative color without any change.

The updating unit 103 compares the provisional representative colors generated by the generating unit 102 with the pixels in the pixel block, performs update when update is required (which will be described later) to generate determined representative colors, and generates update information for updating the provisional colors with the determined representative colors.

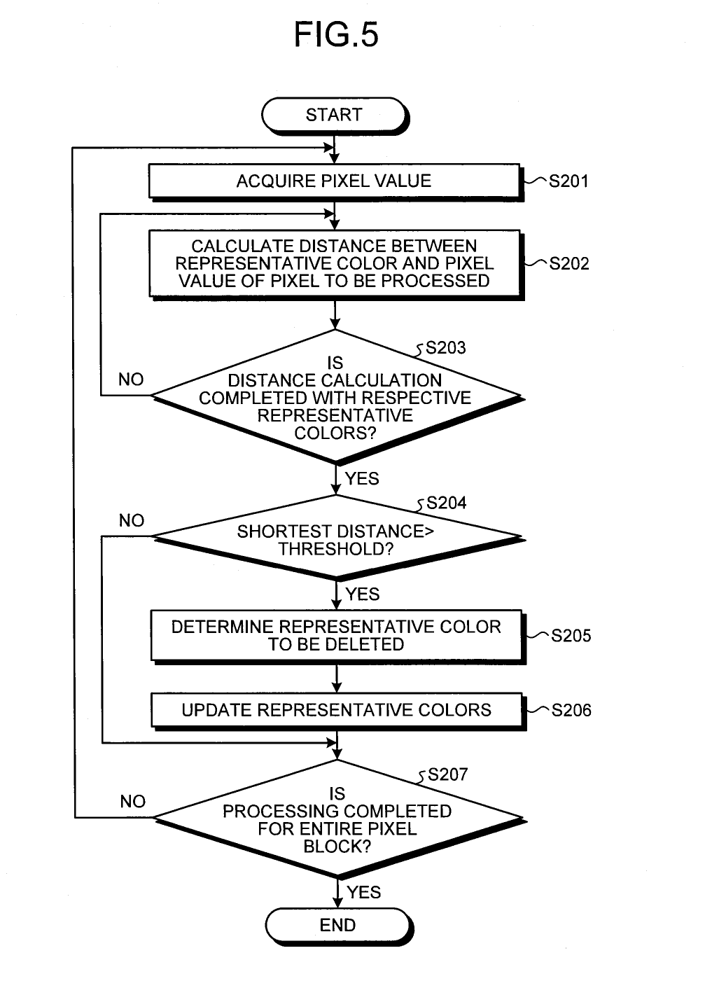

FIG. 5 is a flowchart illustrating the update process in which the updating unit 103 updates the provisional representative colors with the determined representative colors. The updating unit 103 acquires pixel values of pixels to be processed (S201). The updating unit 103 updates the provisional representative colors while scanning the pixels to be processed in the raster scan order, but the update method is not limited thereto.

The updating unit 103 calculates the distance between the pixel value of a pixel to be processed and the pixel value of a provisional representative color (S202). For example, the updating unit 103 calculates the distance between the pixel value of a pixel to be encoded in the pixel block and the pixel value of a provisional color by the following expression 1:

Distance=α×|(R of pixel to be encoded)−(R of provisional color)|+β×|(G of pixel to be encoded)−(G of provisional color)|+γ×|(B of pixel to be encoded)−(B of provisional color)| (1)

where α represents a weighting factor on R, β represents a weighting factor on G, and γ represents a weighting factor on B. Herein, it is assumed that α=β=γ=1 is satisfied, but α=γ=1 and β=2 may be satisfied when priority is given to G taking the Bayer array into consideration. In a case of the YUV color system, when a weighting factor on Y is α, a weighting factor on U is β, and a weighting factor on V is γ, α=2 and β=γ=1 may be satisfied so that priority is given to Y. Furthermore, lower bits may be omitted (that is, the number of bits may be reduced like an arithmetic right shift), for example, without obtaining the differences with the accuracy of 8 bits. As a result of calculating the differences after reducing the number of bits from 8 to 7, the number of bits will be back to 8 even information of 1 bit that is information on positive or negative is added, and it is thus not necessary to increase the number of bits to be processed.

Subsequently, the updating unit 103 determines whether or not the distance calculation is completed between the pixel to be processed and all the provisional colors (S203). If it is determined that the distance calculation is not completed between the pixel to be processed and all the provisional colors (S203: No), the updating unit 103 proceeds to the process of S202. If it is determined that the distance calculation is completed between the pixel to be processed and all the provisional colors (S203: Yes), the updating unit 103 proceeds to the process of S204.

For example, in the example illustrated in FIGS. 3 and 4, when Pix0 is the pixel to be processed, Pix0 has the same pixel as Palette0 and the distance therebetween is therefore 0. Thus, the distance is the shortest.

Subsequently, the updating unit 103 determines whether or not the value of the shortest distance is larger than a predetermined threshold (S204). If the value of the shortest distance is equal to or smaller than the predetermined threshold (S204: No), the updating unit 103 proceeds to the process of S207. If the value of the shortest distance is larger than the predetermined threshold (S204: Yes), the updating unit 103 proceeds to the process of S205.

The updating unit 103 determines an unnecessary representative color (a representative color to be deleted) among the provisional representative colors (S205). Examples of the method for determining an unnecessary provisional representative color by the updating unit 103 include a method of reducing redundant provisional representative colors to one representative color, and a method of determining any of multiple provisional representative colors with high color similarity to be an unnecessary representative color. Alternatively, the updating unit 103 may determine an unnecessary provisional representative color that is selected as the provisional representative color at the shortest distance in the process of S204 the least number of times.

The updating unit 103 deletes the provisional representative color determined to be unnecessary in the process of S205, and updates the provisional representative colors with the determined representative colors using the pixel values of the pixels to be processed (S206). Note that, for updating the value of a representative color, the pixel value of the pixel to be processed may be used without any change, or lower N bits may be quantized to update the value of a representative color, for example.

The updating unit 103 then determines whether or not the processing is completed on all the pixels in the pixel block (S207). If the processing is not completed on all the pixels in the pixel block (S207: No), the updating unit 103 proceeds to the process of S201. If the processing is completed on all the pixels in the pixel block (S207: Yes), the updating unit 103 terminates the processing.

For example, when the processing is performed in the raster scan order on the pixels illustrated in FIG. 3, the shortest distance in the processing of Pix4 is 32, which is larger than the threshold. In this case, the updating unit 103 determines a provisional representative color to be deleted. Note that the updating unit 103 may perform update in another method. For example, the updating unit 103 may use such a method of generating a histogram of colors in the pixel block, determining representative colors in advance on the basis of the color distribution, then comparing the provisional representative colors with the representative colors, and updating the differences therebetween.

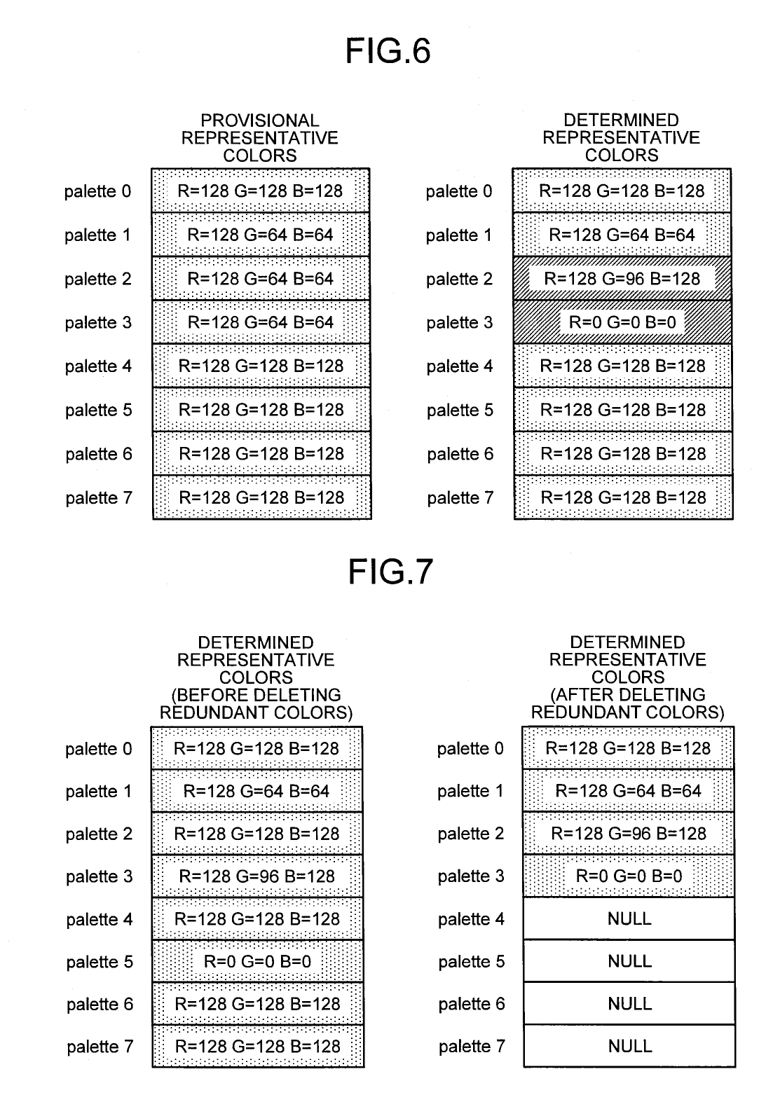

FIG. 6 is a diagram illustrating a result of updating the provisional representative colors. FIG. 6 illustrates an example in which the provisional representative colors Palette2 and Palette3 are updated as a result of the update process by the updating unit 103. The updating unit 103 then generates update information for updating the provisional representative colors with the determined representative colors, and outputs the generated update information.

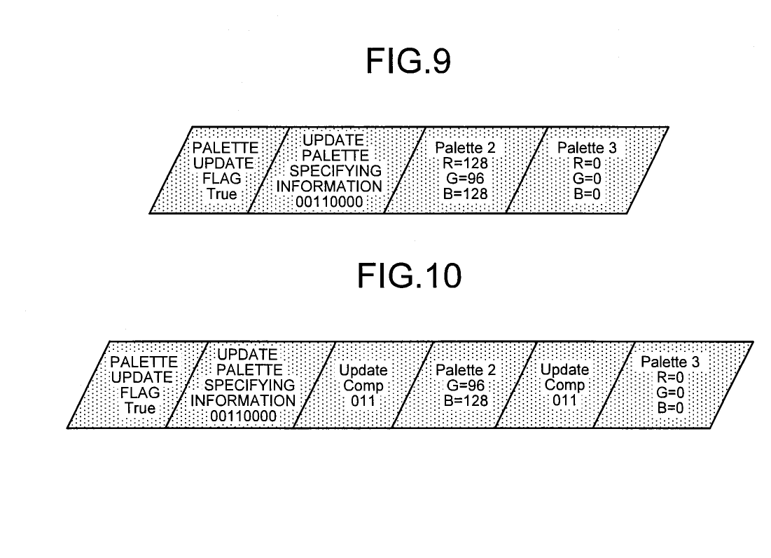

Next, the update information generated by the updating unit 103 will be described. FIG. 9 is a diagram the illustrating update information indicating the update result illustrated in FIG. 6. For example, the updating unit 103 outputs flag information (palette update flag) indicating whether or not palettes are updated at the head of the update information. In the example illustrated in FIG. 6, since Palette2 and Palette3 are updated, the palette update flag is set to true for subsequent encoding by the encoding unit 105.

An example in which whether or not to update each representative color is indicated by 0 (not to update) or 1 (to update) in 8 bits for eight provisional representative colors will be described herein. In the example illustrated in FIG. 6, since Palette2 and Palette3 are updated among Palette0 to Palette7, the updating unit 103 outputs update palette specifying information that specifies palettes to be updated being “00110000.” After outputting the update palette specifying information, the updating unit 103 outputs information indicating R=128, G=96, B=128 that is the updated pixel value of Palette2 in 24 bits and information indicating R=0, G=0, B=0 that is the updated pixel value of Palette3 in 24 bits.

The information of the pixel value may additionally include information further specifying a color component to be updated as illustrated in FIG. 10. For example, in updating Palette2, the pixel value R=128, G=64, B=64 of the provisional representative color is updated with the pixel value R=128, G=96, B=128 of the determined representative color. In this case, since the pixel value for the R component is not changed, the value need not be updated. Thus, as a result of outputting information specifying color components to be updated by the updating unit 103, the encoding unit 105 only needs to encode the color components that need to be updated, which can reduce the amount of information necessary for expressing the pixel value.

In this example, the updating unit 103 expresses whether or not to update each of R, G, and B by 0 (not to update) or 1 (to update) in 1 bit, outputs Update Comp indicating the color components to be updated being “011”, and then outputs the pixel value of G and B that needs to be updated. For updating Palette3, the updating unit 103 outputs the Update Comp indicating the color components to be updated being “111” since update is needed for all the color components, and then outputs the pixel value of all the components R, G and B.

When there is no provisional representative color to be updated, the updating unit 103 outputs the palette update flag set to False. In this case, since the update palette specifying information need not be output, the code amount of 8 bits can be reduced.

Although the example in which the palette update flag is encoded is described herein, a method in which the palette specifying information is always encoded without using the flag information may be employed. Note that the structure of the update information illustrated in FIG. 9 is not limited to the manner described above. For example, the update palette specifying information may be in a form of encoding the number of palettes to be updated and indices specifying the palettes.

Furthermore, the updated pixel value may be subjected to variable-length coding by assigning a shorter code length to a pixel value that is more likely to occur by using Huffman coding or the like to reduce the code length if information on pixel values that are likely to occur is known, instead of encoding the pixel value in a fixed length. Still alternatively, information on the difference between the pixel value of a provisional representative color and the updated pixel value may be subjected to variable-length coding.

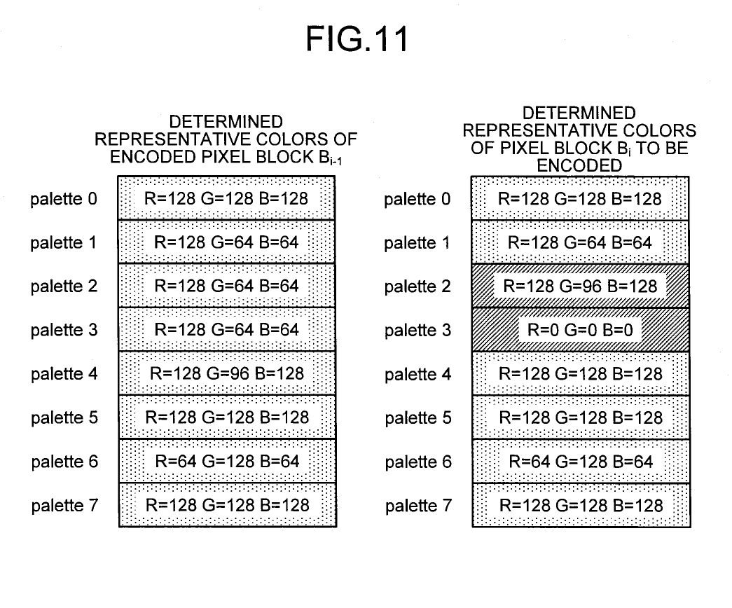

Furthermore, the representative colors of a pixel block Bᵢ to be encoded next may be encoded by using the representative colors of an encoded pixel block Bᵢ₋₁. FIG. 11 is a diagram illustrating the representative colors of the encoded pixel block Bᵢ₋₁ and the representative colors of the pixel block Bᵢ to be encoded next.

FIG. 11 illustrates that the representative colors of Palette2 and Palette3 are updated in the pixel block Bᵢ to be encoded. Here, the pixel value of the representative color of Palette2 is R=128, G=96, B=128, which is the same as that of Palette4 of the representative colors of the encoded pixel block Bᵢ₋₁. Thus, the amount of information for expressing the pixel values of the representative colors of the pixel block Bᵢ can be reduced by outputting a 1-bit flag indicating the presence of a representative color having the same pixel value as any of the representative colors of the encoded pixel block Bᵢ₋₁ and 3-bit information specifying the representative color having the same pixel value instead of outputting 24-bit information on the pixel value.

In addition, for information of the pixel value of Palette3 of the pixel block Bᵢ to be encoded, a 1-bit flag indicating the absence of representative colors having the same pixel value among the representative colors of the encoded pixel block Bᵢ₋₁ is output, and the information on the pixel value is encoded in 24 bits.

Although it is determined whether or not there is any pixel value that is completely the same as that of a representative color in the pixel block Bᵢ to be encoded among the representative colors of the encoded pixel block Bᵢ₋₁ in the example illustrated in FIG. 11, alternatively, a certain threshold may be provided and it may be determined that pixel values match with each other if the difference therebetween is equal to or smaller than the threshold.

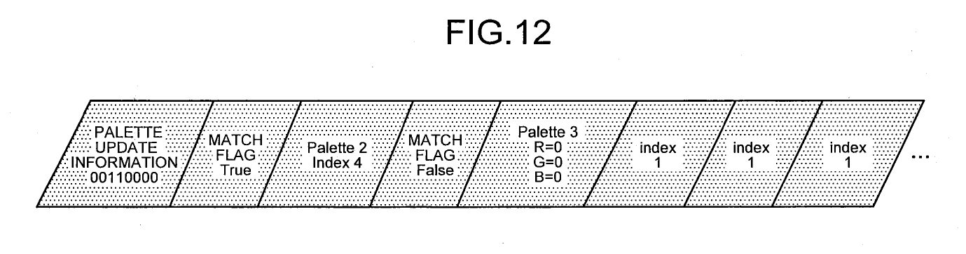

FIG. 12 is a diagram illustrating encoded data resulting from encoding the update information using the encoded pixel block Bᵢ₋₁ illustrated in FIG. 11. In the example of the encoded data illustrated in FIG. 12, the update information, and indices (Index1, Index1, Index1, . . . ) identifying the representative colors assigned to the respective pixels (Pix0 to Pix15) of the pixel block to be encoded are arranged.

Although the process and the information for updating the provisional representative colors are described above using an example in which an unnecessary representative color is deleted and replaced with a new representative color, an update process in which only an unnecessary provisional representative color is deleted or an update process in which only a new representative color is added without deleting any provisional representative colors may be used. Alternatively, the updating unit 103 may perform an update process combining update processes using addition and deletion. In these cases, information indicating whether an update is a deletion of a provisional representative color, an addition of a new representative color, or a replacement of a provisional representative color with a new representative color may be added to the encoded data. Alternatively, a method in which the updating method is switched according to predetermined processing procedures at the encoding side and the decoding side may be used.

FIG. 7 is a diagram illustrating an update result of deleting redundant provisional representative colors to generate final representative colors. As illustrated in FIG. 7, an example in which multiple provisional representative colors having the same pixel value like Palette0, Palette2, Palette4, Palette6, and Palette7 are present before deleting redundant provisional representative colors will be described. In this case, as a result of deleting representative colors such as Palette2, Palette4, Palette6 and Palette7 having the same pixel value as Palette0, the number of representative colors (determined representative colors) can be reduced to four, which are Palette0 to Palette3 in the right in FIG. 7, and the amount of information for expressing indices can thus be reduced from 3 bits of 000 to 111(2) to 2 bits of 00 to 11(2).

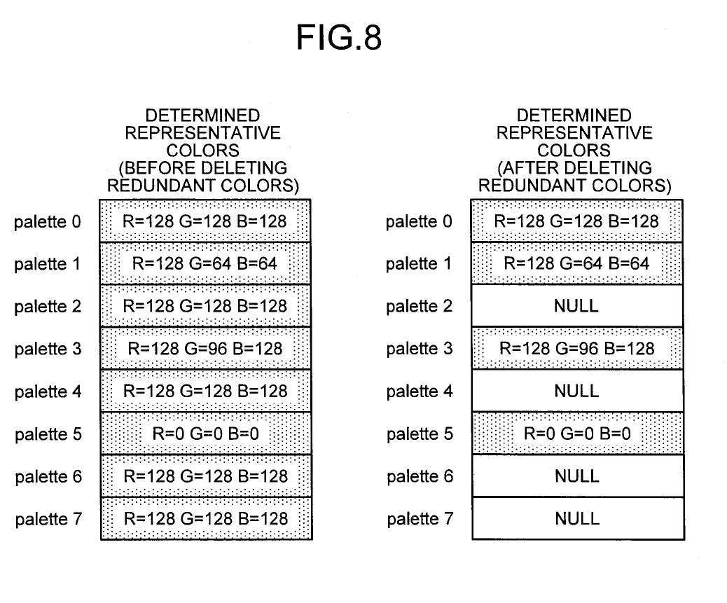

Note that the method for deleting redundant representative colors may be any predetermined method used at the encoding side and the decoding side, and does not limit the present invention. For example, although an example in which the representative colors remaining after deleting provisional representative colors are rearranged as Palettes 0 to 3 is described in the example illustrated in FIG. 7, such as method as illustrated in FIG. 8 in which redundant representative colors are simply deleted may be used.

In this case, since the representative color information can be similarly generated at the decoding side if it is defined that deletion is performed by the same method at the encoding and decoding sides, the representative color assigned to a pixel can be calculated from the index using the 2-bit expression of 00 to 11(2).

For example, if it is defined in advance at the encoding and decoding sides that representative colors that are NULL as a result of deletion are skipped and indices of 00 to 11(2) are assigned, it can be seen that 00(2), 01(2), 10(2), and 11(2) are assigned to Palette0, Palette1, Palette3, and Palette5, respectively. Thus, since the values of the representative colors assigned to the pixels can be calculated from the representative colors remaining after deleting redundant representative colors and the indices, the pixels can be decoded.

Although an example in which a representative color having the same pixel value is deleted as a redundant representative colors is described above, such a method as providing an evaluation measure for evaluating the similarity between representative colors such as a sum of absolute differences and determining representative colors to be redundant if the similarly exceeds a predetermined threshold may be used.

Furthermore a method of deleting a representative color that is not redundant but is unnecessary for encoding the pixel block to be processed may be used. For example, when indices are assigned to the representative colors of the respective pixels in the pixel block to be processed, a representative color to which no indices are assigned can be determined to be unnecessary and can thus be deleted from the representative colors. The method for determining an unnecessary representative color is not limited thereto. For example, for deleting a representative color that is not redundant, information specifying the deleted representative color may be added to the encoded data so that the representative color to be deleted can be identified at the decoding side.

The assigning unit 104 calculates the distance between each of the pixels in the pixel block and the representative color generated in the process of S103, and assigns an index the representative color at the shortest distance. The expression 1 in the process of S202 illustrated in FIG. 5 is applied as the expression for calculating the distance between the color of a pixel to be encoded in the pixel block and a representative color. The expression for calculating the distance, however, is not limited thereto but any other calculation expression may be used. Furthermore, the distance calculation in S202 and the distance calculation in this case may be performed by different methods.

Note that the method for assigning indices is not limited to the method described above. For example, the indices may be assigned by a method allowing the same indices to be likely to be assigned to adjacent pixels so that encoding of indices will be facilitated.

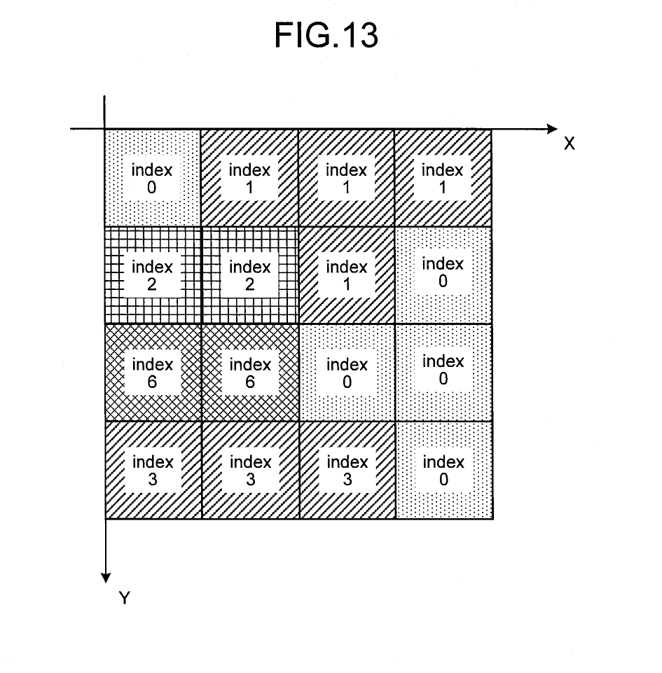

FIG. 13 is a diagram illustrating a result of assigning indices to respective pixels in a pixel block to be encoded. As illustrated in FIG. 13, as a result of assigning indices individually identifying representative colors, any one of the representative colors is assigned to each of the pixels in the pixel block to be encoded.

The encoding unit 105 encodes the update information generated by the updating unit 103 and the assignment information generated by the assigning unit 104. For example, the encoding unit 105 switches the code length of indices on the basis of relative positions of the reference pixels used for generating provisional representative colors and the pixels to be encoded to reduce the code amount of indices.

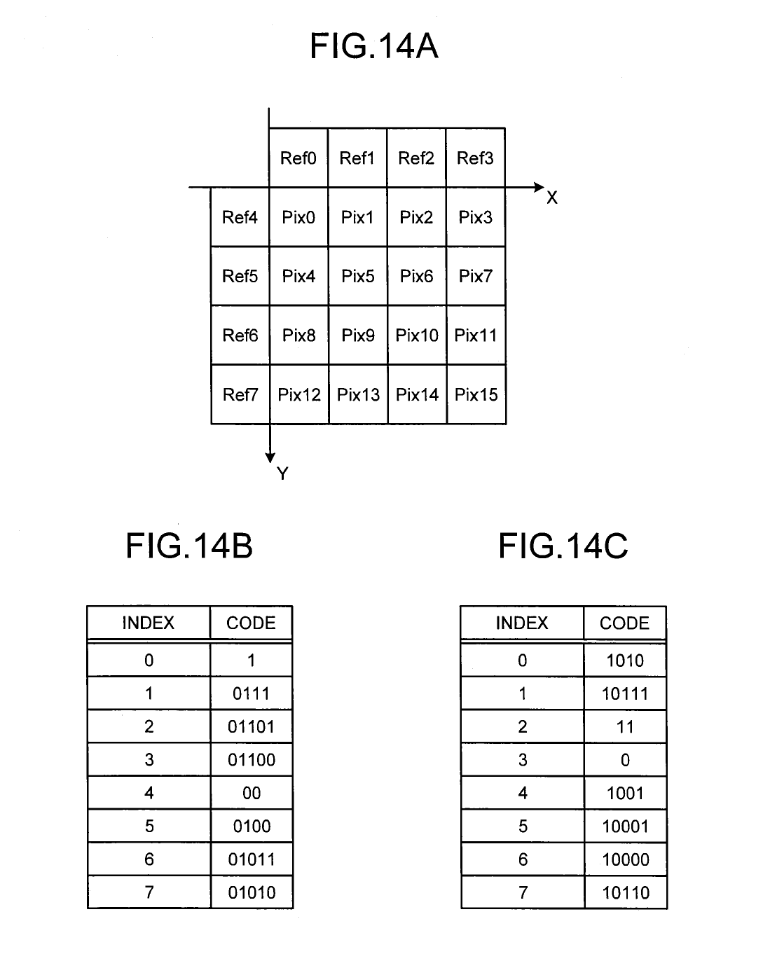

FIGS. 14A to 14C are diagrams illustrating an example of encoding the indices. FIG. 14A is a diagram illustrating relative positions of the reference pixels and the pixels to be encoded. The provisional representative colors are generated by using pixel values of Ref0 to Ref7, for example. The representative colors are updated on the basis of the provisional representative colors. Thus, when indices are assigned on the basis of the similarity between pixel values, the possibility that an index of the provisional representative color generated from the reference pixel at a shorter distance from a pixel to be encoded is assigned is higher because of the correlation of pixel values between adjacent pixels.

For example, in the example illustrated in FIGS. 14A to 14C, the index 0 or the index 4 that is an index of a provisional representative color generated from Ref0 or Ref4 at a shorter relative distance is likely to be assigned to the pixel Pix0. For the index of Pix3, the index 3 or the index 2 that is an index of a provisional representative color generated from the reference pixel Ref3 or Ref2 is likely to be assigned. Thus, the code amount of indices can be reduced by assigning a short code length to an index that is likely to be assigned on the basis of the relative positions of the reference pixels used for generating the provisional representative colors and the pixel to be encoded.

FIG. 14B is a diagram illustrating a code length table at the position of Pix0 illustrated in FIG. 14A. FIG. 14C is a diagram illustrating a code length table at the position of Pix3 illustrated in FIG. 14A. Thus, the encoding unit 105 switches the code length of the index for each of the pixels to be encoded on the basis of the relative positions of the reference pixels and the pixels to be encoded.

The relation between indices and codes is not limited to the codes illustrated in FIGS. 14B and 14C, but any other code table may be used. Furthermore, the encoding unit 105 may further switch the code length table depending on the indices assigned to adjacent encoded pixels in addition to the relative positions of the reference pixels and the pixels to be encoded taking the high possibility that the same index is assigned to adjacent pixels into consideration.

For example, for encoding the index of Pix5, the encoding unit 105 may assign a shorter code length to indices that are likely to be assigned to Pix5 on the basis of the indices assigned to the adjacent encoded pixels Pix0 to Pix2 and Pix4 in addition to the relative positions of Pix5 and the reference pixels.

Note that the encoding of indices is not limited to the method described above. For example, the encoding unit 105 may encode the indices assigned to the respective pixels by expressing the indices 0 to 7 by 000(2) to 111(2) in a fixed length of 3 bits. Alternatively, the encoding unit 105 may use a method of applying variable-length coding using the similarity of indices between adjacent pixels by using run-length coding or a method of switching the code length on the basis of the frequency of occurrence such as Huffman coding.

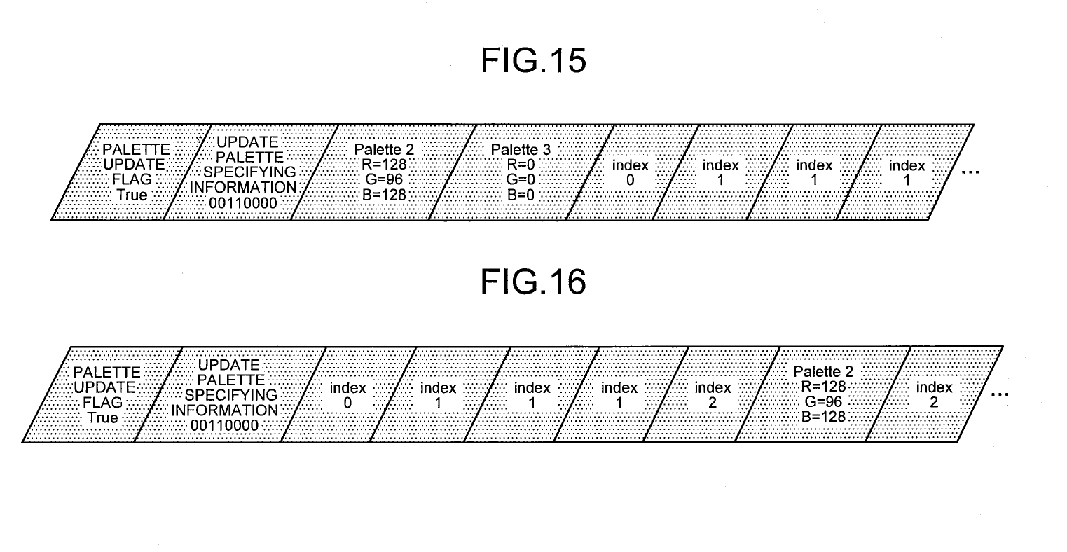

FIG. 15 is a diagram illustrating an example of encoded data encoded and output by the encoding unit 105. In the example of the encoded data illustrated in FIG. 15, the update information, and indices (Index0, Index1, Index1, Index1, . . . ) identifying the representative colors assigned to the respective pixels (Pix0 to Pix15) of the pixel block to be encoded are arranged.

Note that the order in which the encoded data are output is not limited to the example illustrated in FIG. 15. FIG. 16 is a diagram illustrating a modified example of the encoded data illustrated in FIG. 15. The encoding unit 105 may be configured to mix the update information and indices for the respective pixels and output the update information on a representative color when the representative color is first referred to.

As described above, with the image encoding device according to the embodiment, since the update information for updating the representative colors and the assignment information indicating respective indices individually identifying the representative colors assigned to the respective pixels in the pixel block to be encoded are encoded, image data can be efficiently encoded when colors are assigned to the respective pixels of an image in units of pixel blocks and the image is sequentially encoded.

Image Decoding Device

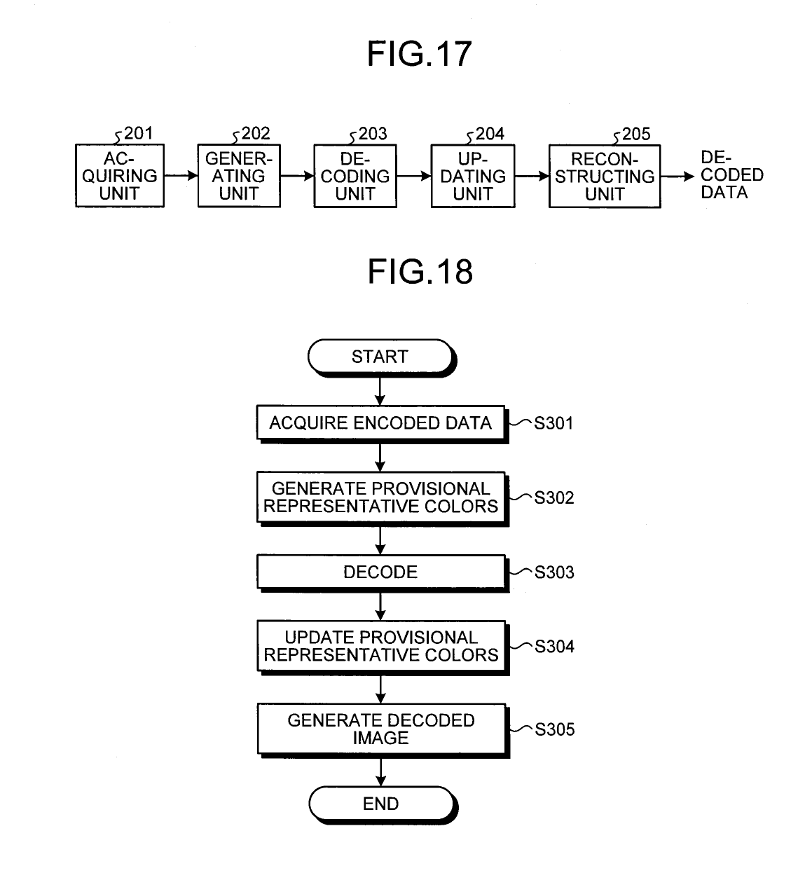

FIG. 17 is a block diagram illustrating an image decoding device according to an embodiment. The image decoding device has functions of a computer including a CPU, a storage unit, a communication interface, and the like, for example. Alternatively, the image decoding device is embedded in an apparatus or a system that mainly handles computer graphics (CG) images such as a screen of a personal computer (PC), for example. The image decoding device decodes encoded data output from the image encoding device illustrated in FIG. 1. Note that the image decoding device may be any device that decodes encoded data output from the image encoding device illustrated in FIG. 1, and is not limited to the configuration illustrated in FIG. 17.

As illustrated in FIG. 17, the image decoding device includes an acquiring unit 201, a generating unit 202, a decoding unit 203, an updating unit 204, and a reconstructing unit 205. Note that the acquiring unit 201, the generating unit 202, the decoding unit 203, the updating unit 204, and the reconstructing unit 205 may be either hardware circuits or software executed by a CPU.

The acquiring unit 201 acquires encoded data to be decoded and a decoded reference pixel block. The generating unit 202 generates one or more provisional representative colors to be used for expressing respective pixels in the pixel block to be decoded and provisional indices for individually identifying the provisional representative colors on the basis of the colors of decoded pixels (reference pixel block, for example), for example.

The decoding unit 203 decodes the encoded data to decode the update information for updating the provisional representative colors and the provisional indices with representative colors and indices and the assignment information assignment information indicating the respective indices assigned to the respective pixels in the pixel block to be decoded.

The updating unit 204 updates the provisional representative colors and the provisional indices with the determined representative colors and indices on the basis of the update information. The reconstructing unit 205 decodes and reconstructs the pixels in the pixel block to be decoded on the basis of the representative colors, the indices and the assignment information.

Next, processes performed by the image decoding device will be described. FIG. 18 is a flowchart illustrating processes performed by the image decoding device.

The acquiring unit 201 acquires encoded data to be decoded and a decoded reference pixel block (S301).

The generating unit 202 generates one or more provisional representative colors to be used for expressing respective pixels in the pixel block to be decoded and provisional indices for individually identifying the provisional representative colors on the basis of the colors of decoded pixels (reference pixel block, for example), for example (S302).

The decoding unit 203 decodes the encoded data to decode the update information for updating the provisional representative colors and the provisional indices with determined representative colors and indices and the assignment information indicating the respective indices assigned to the respective pixels in the pixel block to be decoded (S303).

The updating unit 204 updates the provisional representative colors and the provisional indices with the determined representative colors and indices on the basis of the update information (S304).

The reconstructing unit 205 decodes and reconstructs the pixels in the pixel block to be decoded on the basis of the representative colors, the indices and the assignment information (S305). If there remain encoded data to be processed, the image decoding device returns to the process of S301. If processing on all the encoded data is completed, the image decoding device terminates the decoding process.

As described above, with the image decoding device according to the embodiment, since the update information for updating the representative colors and the assignment information indicating indices individually identifying the representative colors assigned to the respective pixels in the pixel block to be decoded are decoded, encoded data resulting from assigning colors to the pixels in units of pixel blocks and sequentially encoding image data can be efficiently decoded.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image encoding device:
a processor; and
a memory that stores processor-executable instructions that, when executed by the processor, cause the processor to:
generate one or more provisional representative colors for target pixel to be encoded and provisional indices identifying the provisional representative colors based on a color assigned to an encoded pixel;
generate one or more determined representative colors to be used for expressing the pixels in the pixel block and indices for individually identifying the determined representative colors on the basis of the pixels to be encoded and the provisional representative colors, and generate information for updating the provisional representative colors and the provisional indices with the determined representative colors and the indices;
generate assignment information in which the respective indices are assigned to the respective pixels in the pixel block to be encoded; and
encode the information and the assignment information.

2. The device according to claim 1, the processor to:
identifies a provisional representative color that is not assigned to the pixel in the pixel block to be encoded based on distances between pixel values of the pixel in the pixel block to be encoded and the provisional representative colors to generate the determined representative colors and the indices.

3. The device according to claim 1, wherein when some determined representative colors are redundant,
the processor to:
generates assignment information in which any one of the indices that identify the redundant determined representative colors is assigned.

4. The device according to claim 2,
the processor to:
switches code lengths of the indices based on relative positions of the pixel to be encoded and the encoded pixel used for determining the provisional representative colors.

5. The device according to claim 3,
the processor to:
switches code lengths of the indices based on relative positions of the pixel to be encoded and the encoded pixel used for determining the provisional representative colors.

6. The device according to claim 1,
the processor to:
generates the information based on at least either one of presence/absence of redundancy in the provisional representative colors and similarity between the provisional representative colors.

7. An image decoding device:
a processor; and
a memory that stores processor-executable instructions that, when executed by the processor, cause the processor to:
generate one or more provisional representative colors used to express pixel in a pixel block to be decoded and provisional indices individually identifying the provisional representative colors based on color of decoded pixel;
decode the encoded data to decode information for updating the provisional representative colors and the provisional indices with determined representative colors and indices and assignment information in which the respective indices are assigned to the respective pixel in the pixel block to be decoded;
generate the provisional representative colors and the provisional indices with the determined representative colors and the indices based on the information; and
decode and reconstruct the pixel in the pixel block to be decoded based on the determined representative colors, the indices and the assignment information.

8. The device according to claim 7, the processor to:
decode the encoded data to determine whether or not information indicating that the determined representative colors and the indices are different from the provisional representative colors and the provisional indices is present, and
omit generate based on the information if the information indicating that the determined representative colors and the indices are different from the provisional representative colors and the provisional indices is absent.

9. The device according to claim 7, wherein the information contains information indicating, for each color component, whether or not the determined representative colors and the indices are different from the provisional representative colors and the provisional indices.

10. The device according to claim 7, wherein the indices have different code lengths depending on relative positions of the decoded pixel used to generate the provisional representative colors and the provisional indices and the pixel in the pixel block to be decoded.

11. The encoding device
a circuitry that generates one or more provisional representative colors for pixels to be encoded and provisional indices for identifying the provisional representative colors on the basis of colors assigned to encoded pixels;
a circuitry that generates one or more determined representative colors to be used for expressing the pixels in the pixel block and indices for individually identifying the determined representative colors on the basis of the pixels to be encoded and the provisional representative colors, and generate update information for updating the provisional representative colors and the provisional indices with the determined representative colors and the indices;
a circuitry that generates assignment information in which the respective indices are assigned to the respective pixels in the pixel block to be encoded; and
a circuitry that encodes the update information and the assignment information.
